(19) United States
(12) Patent Application Publication
(10) Pub. No.: US 2008/0164692 A1
(43) Pub. Date: Jul. 10, 2008

(54) CLAMPING APPARATUS FOR SUPPORTING AND SEALING JOINED PIPES

(76) Inventor: David M. Goggin, Loveland, CO (US)

Correspondence Address: COCHRAN FREUND & YOUNG LLC, 2026 CARIBOU DR, SUITE 201, FORT COLLINS, CO, 80525, US

(21) Appl. No.: 11/620,505

(22) Filed: Jan. 5, 2007

(51) Int. Cl. F16L 23/036

(52) U.S. Cl. 285/236

(57) ABSTRACT

An apparatus for supporting and sealing connections made between male and female cylindrical metallic dryer vent pipes is described. An elongated cylindrical clamping apparatus having a longitudinal opening through the surface thereof permitting the apparatus to be opened to encircle joined pipe members, and including clamping straps and optionally a rubbery sealing material disposed inside of the clamping apparatus to provide an improved gas seal permits the connection to be firmly held together without using rivets or screws. For pipe connections where an elbow is involved, two elongated cylindrical clamping devices may be used, and additional screw-type straps may be employed to connect the two devices with one or more straps being disposed over the heal of the elbow, and at least two straps crisscrossed over the throat of the elbow for added stability.

### FIELD OF THE INVENTION

The present invention relates generally to venting systems for clothes driers and, more particularly, to apparatus for holding joined dryer vent pipes in place, and for sealing joints therebetween.

### BACKGROUND OF THE INVENTION

Clothes dryers vent hot air from the appliance to the outside of the house. Lint becomes detached from the clothes and is carried our through the exhaust. Fires can occur when lint builds up in the dryer or in the exhaust duct, thereby slowing the air movement through the dryer and the exhaust system. Slower air movement causes more lint to be collected on the backside of the dryer drum, on the motor or on the electrical connections inside the dryer, and causes excessive heat build-up in the dryer motor. Highly combustible lint, when placed on or in the proximity of heat sources can readily ignite.

Dryer venting tends to sag if it is not guided through the rafters with rigid ducting, the curves further arresting lint movement out of the vent. The use of sheet metal or circular metal vent pipes, and the use of pop rivets instead of screws to connect metal vent pipe pieces are helpful in this regard, since metal pipes are more fire resistant than the customary 4″ diameter white-plastic or aluminum-foil exhaust ducts, cannot readily be crushed between the dryer and the wall, and help contain a fire in the event thereof. Pop rivets do not collect as much lint as threaded screws inside of the vent pipe, but still affect the smooth flow of air within the pipe. Further, directing airflow through vent pipes from the female end thereof to the male end has been found to reduce lint accumulation in the region of the joints with other pipes.

Metal vent pipe joints are generally sealed using duct tape, Foil Scrim Kraft (FSK) tape or aluminum foil tape to reduce air leakage. Duct tape dries out over time and detaches from the pipe, thereby permitting the pipe sections to separate and lint and dust to enter the house. Aluminum foil tape and FSK tape also dry and eventually detach from the pipe, causing the same result.

In U.S. Pat. No. 4,172,607 for “Pipe Coupling With Plastic Sheath” which issued to Bernard W. Norton on Oct. 30, 1979, a pipe coupling including an annular elastic gasket fitted over two adjacent pipe ends and tightened down with encircling clamp bands is described. The coupling includes a plastic band surrounding the elastic gasket, with overlapping ends tapered in thickness. Metal clamp bands encircle the plastic band and are retained in place by ridges forming channels on the outside surface of the plastic band. In U.S. Pat. No. 4,026,586 for “Plain End Pipe Joint” which issued to Harold Kennedy and Robert M. Graham on May 31, 1977, an elongated clamping strip reinforced at its ends for joining the plain ends of pipes is described. The strip has edges that will deform under a given load more than its central portion, and a short strip to bridge the area where the two ends of the clamping strip are clamped together.

U.S. Pat. No. 4,186,948 for “Pipe Joint Clamp” which issued to Allan D. Cronk on Feb. 5, 1980, describes a generally circular pipe joint clamp able to compress a flexible packer around a joint between substantially aligned pipes. The clamp includes a plurality of plates forming a flexible shield, each plate overlapping one neighboring plate and underlying the other neighboring plate. A joint between each pair of neighboring plates, except for the plates at each end of the flexible shield, permit the plates to pivot relative to one another. Clamps allow a compressing force to be applied to the flexible shield.

Circular dryer vent pipes are presently manufactured with a circumferential raised portion between the crimped, male open end thereof and the remainder of the pipe, and an opposing circular female open end. The raised portion prevents the male portion of one pipe from being inserted beyond the crimped portion into the female open end of a mating pipe.

Accordingly, it is an object of the present invention to provide an apparatus for supporting and sealing joined circular dryer vent pipes.

Another object of the invention is to provide an apparatus for supporting and sealing circular dryer vent pipes by holding the circumferential raised portion of a male portion of one pipe against the female end of a second vent pipe into which the male portion of the first pipe is inserted.

Yet another object of the present invention is to provide an apparatus for supporting and sealing circular dryer vent pipes to elbows.

Still another object of the invention is to provide an apparatus for supporting and sealing a first circular dryer vent pipe to a circular dryer vent elbow by holding the circumferential raised portion of the male portion of the first pipe against the female end of the elbow into which the male portion of the first vent pipe is inserted, and for supporting and sealing a second circular dryer vent pipe to the elbow by holding the circumferential raised portion of the male portion of the elbow against the female end of the second dryer vent pipe into which the male portion of the elbow is inserted.

Additional objects, advantages and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the apparatus for supporting and sealing a joint formed from a male portion of a first cylindrical dryer exhaust pipe inserted into a mating portion of a second cylindrical dryer exhaust pipe, including: an elongated cylindrical band having a chosen length, an inside surface, an outside surface, and having a first open end adapted to receive a portion of the first pipe and a second open end adapted to receive the female portion of the second cylindrical dryer exhaust pipe, the cylindrical band further having a longitudinal opening through its surface along the entire length thereof defining a first edge and a second edge; and means for clamping the cylindrical band around the portion of the first pipe and the portion of the second pipe, whereby the first pipe and the second pipe are firmly held together.

In another aspect of the present invention, in accordance with its objects and purposes, the apparatus for supporting and sealing a first joint formed from a male portion of a first cylindrical dryer exhaust pipe inserted into a mating portion of a dryer exhaust pipe elbow, and a second joint formed from a male portion of the elbow inserted into a mating portion of a second cylindrical dryer exhaust pipe, including: a first elongated cylindrical band having a chosen length, an inside surface, an outside surface, and having a first open end adapted to receive a portion of the first cylindrical dryer exhaust pipe and a second open end adapted to receive a mating portion of the elbow, the first cylindrical band further having a first longitudinal opening through its surface along the entire length thereof defining a first edge and a second edge; a second elongated cylindrical band having a chosen length, an inside surface, an outside surface, and having a third open end adapted to receive a second portion of the elbow and a fourth open end adapted to receive the mating portion of the second cylindrical dryer exhaust pipe, the second cylindrical band further having a second longitudinal opening through its surface along the entire length thereof defining a third edge and a fourth edge; first means for clamping the first cylindrical band around the portion of the first pipe and the mating portion of the elbow, whereby the first pipe and the elbow are firmly held together; and second means for clamping the second cylindrical band around the second portion of the elbow and the mating portion of the second pipe, whereby the second pipe and the elbow are firmly held together.

Benefits and advantages of the present invention include, but are not limited to, reducing lint accumulation in dryer vent pipes while maintaining rigid, well-sealed connections between pipes without using rivets or threaded screws to keep the joints rigid, and without using duct tape, Foil Scrim Kraft (FSK) tape or aluminum foil tape to reduce air leakage therefrom.

### BRIEF DESCRIPTION OF THE DRAWINGS

The accompanying drawings, which are incorporated in and form a part of the specification, illustrate two embodiments of the apparatus of the present invention and, together with the description, serve to explain the principles of the invention. In the drawings:

FIG. 1A is a schematic representation of a projection view of the male portion of a dryer vent pipe, and the corresponding mating portion of a female dryer vent pipe into which the male portion may be inserted, and illustrates the circumferential bead on the male portion which limits the distance the male portion can be inserted into the female pipe, as shown in FIG. 1B hereof.

FIG. 2 is a schematic representation of a projection view of an embodiment of the pipe clamping apparatus of the present invention suitable for holding and sealing connections between straight cylindrical pipe sections.

FIG. 3 is a schematic representation of a projection view of a second embodiment of the pipe clamping apparatus hereof suitable for holding and sealing connections between straight cylindrical pipes through an elbow section.

### DETAILED DESCRIPTION OF THE INVENTION

Briefly, the present invention includes an apparatus for supporting and sealing connections made between male and female cylindrical metallic dryer vent pipes. An elongated cylindrical clamping apparatus having a longitudinal opening through the surface thereof permitting the apparatus to be opened to encircle joined pipe members, and including clamping straps and optionally a rubbery sealing material which is disposed inside of the clamping apparatus to provide an improved gas seal, thereby permitting the connected pipes to be firmly held together without using rivets or screws. The clamping straps may be of the screw or worm type, commonly used as hose clamps.

For pipe connections where an elbow is involved, two elongated cylindrical clamping devices may be used, where additional screw-type straps may be used to connect the two devices with one or more straps being disposed over the heal of the elbow, and at least two straps crisscrossed over the throat of the elbow for added stability.

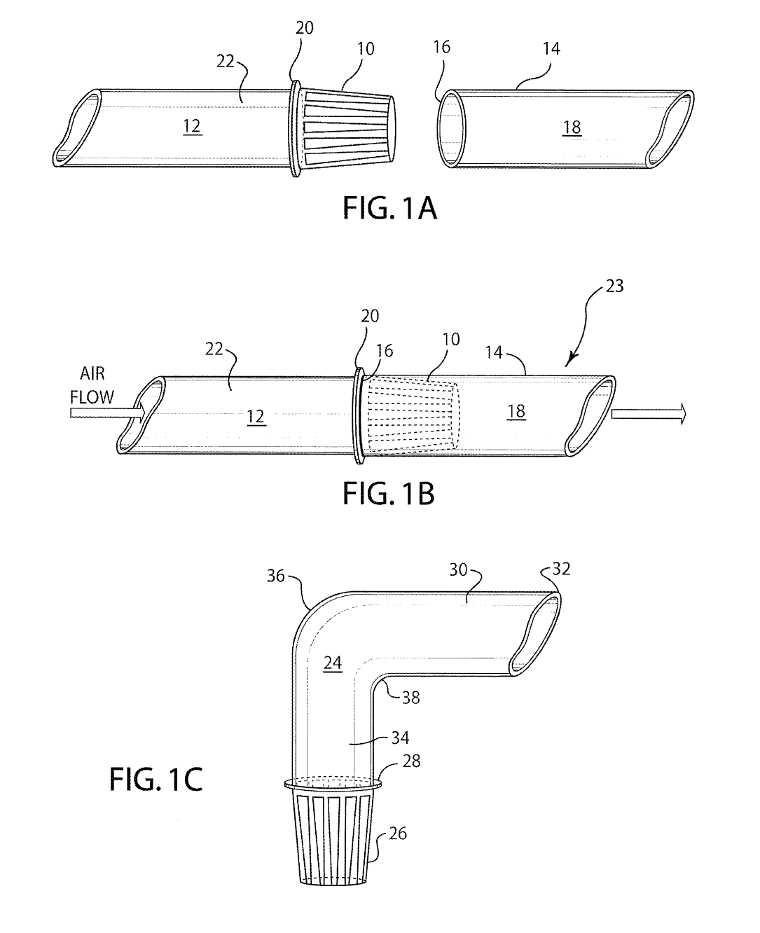

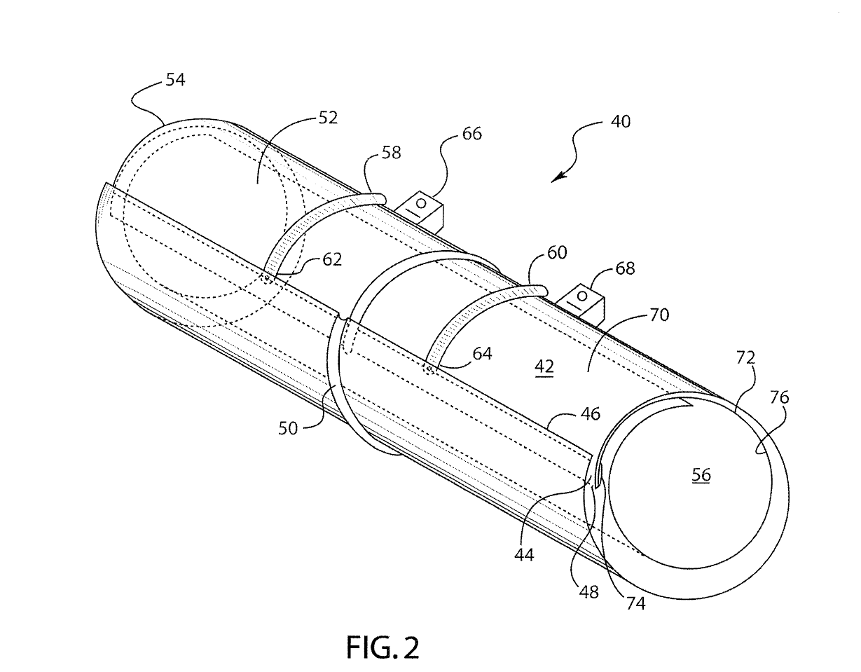

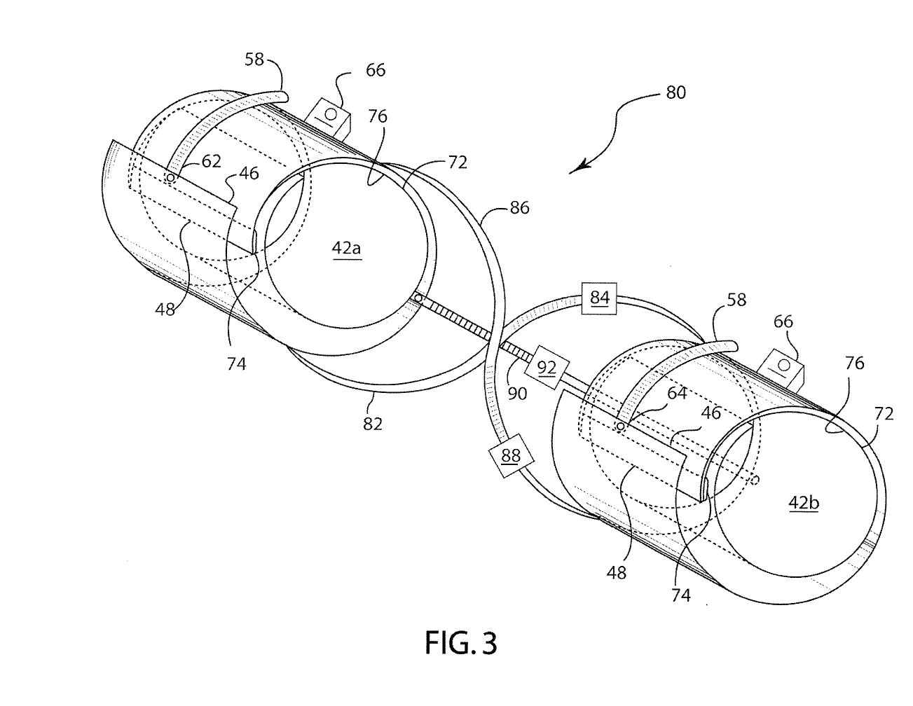

Reference will now be made in detail to the present embodiments of the present invention, examples of which are illustrated in the accompanying drawings. Similar or identical structure is identified using identical callouts. Turning now to the FIGURES, FIG. 1A is a schematic representation of a projection view of tapered male portion, 10, of dryer vent pipe, 12, and the mating portion, 14, having opening, 16, of female dryer vent pipe, 18, into which male portion 10 is inserted. Circumferential bead, 20, formed on the surface of pipe 12 limits the depth into which male portion 10 can be inserted into mating female portion 14 by engaging opening 16 of pipe 18. Portion, 22, of the outer surface of pipe 12 behind bead 20 will be discussed in more detail in FIG. 2 hereof. FIG. 1B is a schematic representation of a projection view of male portion 10 of dryer vent pipe 12 inserted into the mating portion of pipe 18 to where bead 20 contacts open end 16 of pipe 18, forming assembled pipe joint, 23, and the preferred direction of flow through dryer vent joint 23, while FIG. 1C is a schematic representation of a projection view of vent pipe elbow, 24, having tapered male portion, 26, circumferential bead, 28, and male pipe receiving portion, 30, having opening, 32, which functions in a similar manner to the mating portion of pipe 18 illustrated in FIG. 1A hereof. Also identified are heel portion, 36, and throat portion, 38, of elbow 24. Portion, 34, of the outer surface of elbow 24 behind circumferential bead 28 will be discussed in more detail in FIG. 3 hereof.

FIG. 2 is a schematic representation of a projection view of an embodiment of the pipe clamping apparatus, 40, of the present invention suitable for holding and sealing connections between straight cylindrical pipe sections. Shown is cylindrical clamp, 42, having longitudinal opening, 44, in its surface defining longitudinal edges, 46, and 48. Rolled portion, 50, in portion, 52, of clamp 40 is adapted to receive and hold circumferential bead 20 of pipe 12 (FIG. 1A), when opening 44 is spread apart a sufficient distance to fit around assembled joint 23 illustrated in FIG. 1B. It should be mentioned that pipes 12 and 18 can alternatively be individually inserted into ends, 54, and, 56, of clamp 40, respectively.

Clamp straps, 58, and, 60, attached to clamp 42 at positions, 62, and, 64, respectively, near edge 46 thereof may then be inserted into worm screw mechanisms, 66, and, 68, respectively, whereby portions 52 and, 70, of clamp 42 can be made to firmly clamp and hold joined pipes 12 and 18 at surfaces 22 and 14, respectively. It should be mentioned that unattached worm clamps may be used to clamped portions 52 and 70, as another example of clamping apparatus, and that fewer or greater number of adjustable, worm-screw clamping apparatus may be employed. It should also be mentioned that for dryer vent pipes not having circumferential bead 20; that is, for pipe connections formed in the field using a crimping tool, clamp 42 may also be used. Moreover, clamp 42 may be fabricated without rolled portion 50 for such vent pipes.

In situations where a more complete seal of joined vent pipes 23 is desired, rubberized, flexible, heat and moisture resistant gasketing material, 72, may be disposed inside clamp 40. Fold, 74, in edge 48 may be made to hold one end of gasketing material 72. Gasketing material 72 may have an adhesive side, 76, covered by removable paper to improve sealability of joined vent pipes 23.

FIG. 3 is a schematic representation of a projection view of a second embodiment, 80, of the pipe clamping apparatus hereof suitable for holding and sealing connections between straight cylindrical pipes through an elbow section shown in FIG. 1C hereof. Two clamps, 42a and 42b, similar in design to that illustrated in FIG. 2 hereof and described hereinabove, are connected by adjustable worm drive clamping straps, 82, 84, and, 86, 88, for crossing over heal portion 36 of elbow 24, and adjustable worm drive clamping mechanism, 90, 92, for crossing throat portion, 38, of elbow 24, to add rigidity to the elbow pipe joints (not shown in FIG. 3).

In use, one clamp, for example 42a, would hold a male portion of a pipe inserted into open end 32 of mating portion 30 of elbow 24, while clamp 42b would hold the mating portion of a pipe into which tapered portion 26 of male portion 34 of elbow 24 is inserted. In some circumstances, it may be desirable to form a circumferential rolled portion 50 in one or both of clamps 42a and 42b for added strength (not shown in FIG. 3).

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for supporting and sealing a joint formed from a male portion of a first cylindrical dryer exhaust pipe inserted into a mating portion of a second cylindrical dryer exhaust pipe, wherein said male portion has a circumferential raised bead for limiting the distance said male portion can be inserted into said mating portion, said apparatus comprising in combination:
(a) an elongated cylindrical band having a chosen length, an inside surface, an outside surface, and having a first open end adapted to receive a portion of said first pipe and a second open end adapted to receive the female portion of said second cylindrical dryer exhaust pipe, said cylindrical band further having a longitudinal opening through its surface along the entire length thereof defining a first edge and a second edge and a concave circumferential portion approximately equidistant between the first open end and the second open end in the inside surface adapted for engaging the circumferential raised bead of said male pipe; and
(b) means for clamping said cylindrical band around the portion of said first pipe and the portion of said second pipe, whereby said first pipe and said second pipe are firmly held together.

2. The apparatus of claim 1, wherein said elongated band comprises a metallic band fabricated from metals selected from the group consisting of aluminum, stainless steel and galvanized steel.

3. The apparatus of claim 1, wherein said elongated band is sufficiently flexible such that the first edge of the longitudinal opening and the second edge of the longitudinal opening can be spread apart a distance sufficient to permit the portion of said first pipe and the mating portion of said second pipe to be inserted into the elongated band therethrough.

4. The apparatus of claim 3, wherein the first edge of the longitudinal opening overlaps the second edge of the longitudinal opening of said elongated band.

5. The apparatus of claim 1, further comprising a heat and moisture resistant layer of material between the inside surface of said elongated band and the outer surface of the portion said first pipe and the outer surface of the mating portion of said second pipe for sealing the joint.

6. The apparatus of claim 5, wherein the second edge of the longitudinal opening is folded over a distance effective for capturing and holding a portion of said heat and moisture resistant layer.

7. (canceled)

8. (canceled)

9. (canceled)

10. The apparatus of claim 1, wherein said means for clamping comprises at least one screw-drive clamp encircling said elongated band.

11. The apparatus of claim 10, wherein said at least one screw-drive clamp comprises an elongated strap connected to said elongated band in the vicinity of the first edge thereof, and a screw mechanism attached to the surface of said elongated band adapted for receiving said elongated strap and adjusting the length thereof.

12. An apparatus for supporting and sealing a first joint formed from a male portion of a first cylindrical dryer exhaust pipe inserted into a mating portion of a dryer exhaust pipe elbow, and a second joint formed from a male portion of said elbow inserted into a mating portion of a second cylindrical dryer exhaust pipe, said apparatus comprising in combination:
(a) a first elongated cylindrical band having a chosen length, an inside surface, an outside surface, and having a first open end adapted to receive a portion of said first cylindrical dryer exhaust pipe and a second open end adapted to receive a mating portion of said elbow, said first cylindrical band further having a first longitudinal opening through its surface along the entire length thereof defining a first edge and a second edge;
(b) a second elongated cylindrical band having a chosen length, an inside surface, an outside surface, and having a third open end adapted to receive a second portion of said elbow and a fourth open end adapted to receive the mating portion of said second cylindrical dryer exhaust pipe, said second cylindrical band further having a second longitudinal opening through its surface along the entire length thereof defining a third edge and a fourth edge;
(c) first means for clamping said first cylindrical band around the portion of said first pipe and the mating portion of said elbow, whereby said first pipe and said elbow are firmly held together; and
(d) second means for clamping said second cylindrical band around the second portion of said elbow and the mating portion of said second pipe, whereby said second pipe and said elbow are firmly held together.

13. The apparatus of claim 12, wherein said first elongated band and said second elongated band comprise metallic bands fabricated from materials selected from the group consisting of aluminum, stainless steel and galvanized steel.

14. The apparatus of claim 12, wherein said first elongated band is sufficiently flexible such that the first edge of the first longitudinal opening and the second edge of the first longitudinal opening can be spread apart a distance sufficient to permit the mating portion of said first pipe and the first portion of said elbow to be inserted into the first elongated band therethrough, and wherein said second elongated band is sufficiently flexible such that the third edge of the second longitudinal opening and the fourth edge of the second longitudinal opening can be spread apart a distance sufficient to permit the second portion of said elbow and the mating portion of said second pipe to be inserted into the second elongated band therethrough.

15. The apparatus of claim 14, wherein the first edge of the first longitudinal opening overlaps the second edge of the first longitudinal opening of said first elongated band, and wherein the third edge of the second longitudinal opening overlaps the fourth edge of the second longitudinal opening of said second elongated band.

16. The apparatus of claim 12, further comprising a first heat and moisture resistant layer of material between the inside surface of said first elongated band and the outer surface of said first pipe and said elbow for sealing the first joint, and a second heat and moisture resistant layer of material between the inside surface of said second elongated band and the outer surface of said elbow and said second pipe for sealing the second joint.

17. The apparatus of claim 16, wherein the second edge of the first longitudinal opening is folded over a distance effective for capturing and holding a portion of said first heat and moisture resistant layer, and wherein the fourth edge of said second longitudinal opening is folded over a distance effective for capturing and holding a portion of said second heat and moisture resistant layer.

18. (canceled)

19. (canceled)

20. (canceled)

21. (canceled)

22. (canceled)

23. The apparatus of claim 12, wherein said first means for clamping comprises at least one first screw-drive clamp encircling said first elongated band, and said second means for clamping comprises at least one second screw-drive clamp encircling said second elongated band.

24. The apparatus of claim 23, wherein said at least one first screw-drive drive clamp comprises a first elongated strap connected to said first elongated band in the vicinity of the first edge thereof, and a screw mechanism attached to the surface of said first elongated band adapted for receiving said first elongated strap and adjusting the length thereof, and wherein said at least one second screw-drive clamp comprises a second elongated strap connected to said second elongated band in the vicinity of the third edge thereof, and a screw mechanism attached to the surface of said second elongated band adapted for receiving said elongated strap and adjusting the length thereof.

25. The apparatus of claim 23, wherein said first means for clamping and said second means for clamping further comprise at least one third screw-drive clamp connecting said first elongated band with said second elongated band and disposed across the heal of said elbow.

26. The apparatus of claim 23, wherein said first means for clamping and said second means for clamping further comprise at least two fourth screw-drive clamps connecting said first elongated band with said second elongated band and disposed over the throat of said elbow.

27. The apparatus of claim 26, wherein said at least two fourth screw-drives are crisscrossed over the throat of said elbow.
